(19) United States
(12) Patent Application Publication
(10) Pub. No.: US 2016/0189834 A1
(43) Pub. Date: Jun. 30, 2016

(54) MAGNETOCALORIC MATERIALS CONTAINING B

(71) Applicant: BASF SE, Ludwigshafen (DE)

(72) Inventors: Francois GUILLOU, Delfgauw (NL); Ekkehard BRUECK, Delf (NL); Bernard Hendrik REESINK, Winterswijk-Kotten (NL)

(73) Assignee: BASF SE, Ludwigshafen (DE)

(21) Appl. No.: 14/910,924

(22) PCT Filed: Jul. 15, 2014
(86) PCT No.: PCT/EP2014/065107

§ 371 Date: Feb. 8, 2016

(30) Foreign Application Priority Data
Aug. 9, 2013 (EP) 13179960.3

(51) Int. Cl. H01F 1/01; F25B 21/00

(52) U.S. Cl. CPC H01F 1/015; F25B 21/00; F25B 2321/002

(57) ABSTRACT

A magnetocaloric material of the general formula (I) (MnₓFe₁₋ₓ)₂₊ᵤ P_{1-y-z}Si_{y}B_{z} wherein 0.25≦x≦0.55, 0.25≦y≦0.65, 0<z≦0.2−0.1≦u≦0.05, and y+z≦0.7.

The present invention relates to materials having a large magnetocaloric effect (MCE), more precisely to those materials combining a large entropy change, a large adiabatic temperature change, a limited hysteresis and excellent mechanical stability; and also to the processes for preparing/producing such materials.

For magnetic materials, magnetic phase transitions manifest themselves by an anomaly on the entropy versus temperature curve, that is to say by an entropy rise. Due to the intrinsic sensitivity of magnetic phase transitions to the application of an external magnetic field, it is possible to shift in temperature this entropy anomaly by a magnetic field change. Depending on whether the field change is performed in isothermal or adiabatic conditions, the effect is quantified either as an entropy change (ΔS) or an adiabatic temperature change (ΔT_{ad}) and is called magnetocaloric effect (MCE). For a ferromagnetic compound around the Curie temperature (T_{C}), increasing the magnetic field leads to a shift of the entropy anomaly toward higher temperatures, the resulting MCE is thus a negative entropy change and a positive temperature change. Magnetic phase transitions can be induced either by a magnetic field change or by a temperature change.

Systems using the magnetocaloric effect cover a broad range of practical applications, from thermomagnetic devices wherein the machine converts a thermal energy into a magnetic work, to heat pumps wherein magnetic work is used to transfer thermal energy from a cold source to a hot sink or vice versa. The former type includes devices that use in a second step the magnetic work: to produce electricity (generally referred to as thermomagnetic, thermoelectric and pyromagnetic generators) or to create a mechanical work (like thermo-magnetic motors). While the latter type corresponds to magnetic refrigerators, heat exchangers, heat pumps or air conditioning systems.

For all these devices it is of primary interest to optimize the heart of the device, the MCE material, also called magnetocaloric material. This MCE is quantified either as an entropy change (ΔS) or a temperature change (ΔT_{ad}), depending on whether the field application is performed in isothermal or in adiabatic conditions, respectively. Often only the ΔS is considered, but since there is no direct relation linking these two quantities, there is no reason to give a preference to only one parameter and thus, it is required to simultaneously optimize both.

All the MCE applications previously cited have a cyclic character, i.e. the magnetocaloric material runs through the magnetic phase transition frequently, it is thus important to ensure the reversibility of the MCE when either field or temperature oscillations are applied. This means, that the magnetic field or thermal hysteresis which could take place around the MCE has to be kept low.

From a practical point of view, in order to allow large-scale applications, the MCE material must be formed of elements available in large amounts, not expensive and not classified as toxic.

For applications using the MCE caused by application of magnetic field changes, the MCE must be preferably achieved by magnetic field changes of the order of what can be provided by permanent magnet such as ΔB≦2 T, and more preferably ΔB≦1.4 T.

Another practical requirement for applications is related to the mechanical stability of the material. The fact is that the most attractive MCE materials take advantage from the discontinuous change in magnetization occurring at first order transitions. However, first order transitions lead to discontinuities on other physical parameters including the unit cell in case of solid materials having a crystalline structure. This “structural” part of the transition gives manifold changes: symmetry breaking, cell volume change or anisotropic cell parameters changes etc. The most dramatic parameter for the stability of bulk polycrystalline samples turns out to be the cell volume change. During thermal or magnetic field cycling, the strains generated by a volume change lead to fractures or a destruction of the bulk piece, which can severely hinder the applicability of these materials. Having a zero volume change at the first order transition is thus a first step to ensure a good mechanical stability.

U.S. Pat. No. 7,069,729 presents magnetocaloric materials of the general formula MnFe(P₁₋ₓAsₓ), MnFe(P₁₋ₓSbₓ) and MnFeP_{0.45}As_{0.45}(Si/Ge)_{0.0} which, generally, do not fulfill the toxicity condition.

U.S. Pat. No. 8,211,326 discloses magnetocaloric materials of general formula MnFe(P_{w}GeₓSi_{z}) which include a critical element (Ge, scarce and expensive) improper for large scale applications.

US 2011/0167837 and US 2011/0220838 disclose magnetocaloric materials of general formula (MnₓFe₁₋ₓ)_{2+z}P_{1-y}Si_{y}. These materials have a significant ΔS but not necessarily the combination of large ΔS and large ΔT_{ad} suitable for most of the applications. Materials having a ratio of manganese to iron (Mn/Fe) of 1 show large hysteresis. This is disadvantageous in respect to the application of the magnetocaloric effect in machines with cyclic operation. Changing the ratio of manganese to iron (Mn/Fe) away from 1 leads to a decrease of the hysteresis of the compounds. Unfortunately it has turned out that the improvement in respect to hysteresis is paid by a decrease of the saturation magnetization, see N. H. Dung et al. Phys. Rev. B 86, 045134 (2012). For MCE purposes the magnetization of the magnetocaloric material used should be high.

CN 102881393 A describes Mn_{1.2}Fe_{0.8}P_{1-y}Si_{y}B_{z} with 0.4≦y≦0.55 and 0≦z≦0.05. According to the data shown the addition of B seems to shift the Curie temperature of the materials towards higher temperatures, but seems to have no effect on the hysteresis according to the experimental data presented. The ΔT_{ad} values achievable in magnetic cooling operations with the materials described are not disclosed.

It was the object of the present invention to provide magnetocaloric materials having a broad range of working temperatures and combining large ΔS and ΔT_{ad} in intermediate fields (ΔB≦2 T, preferably ΔB≦1.4 T), high saturation magnetization, a limited hysteresis and a limited cell volume change.

This object is achieved by magnetocaloric materials of the general formula (I)

(MnₓFe₁₋ₓ)₂₊ᵤP_{1-y-z}Si_{y}B_{z}

wherein
0.25≦x≦0.55,
0.25≦y≦0.65,
0<z≦0.2,
−0.1≦u≦0.05, and
y+z≦0.7.

A further aspect of the present invention relates to a process for producing such magnetocaloric materials, the use of such magnetocaloric materials in cooling systems, heat exchangers, heat pumps or thermoelectric generators and cooling systems, heat exchangers, heat pumps or thermoelectric generators containing the inventive magnetocaloric materials.

The inventive magnetocaloric materials are formed from elements which are generally classified as non-toxic and non-critical. The working temperature of the inventive magnetocaloric materials is in the range from −100° C. to +150° C. which is beneficial for use in a wide range of cooling applications like refrigerators and air conditioning. The inventive magnetocaloric materials have very beneficial magnetocaloric properties; in particular they exhibit large values of ΔS and at the same time large values of ΔT_{ad} and show very low thermal hysteresis. Furthermore, the inventive materials undergo only very small or practically no cell volume change during the magnetic phase transition. This leads to a higher mechanical stability of the materials during continuous cycling which is mandatory for actual application of magnetocaloric materials.

The stoichiometric value x is preferably at least 0.3, more preferred at least 0.35, most preferred at least 0.4, in particular at least 0.45. The maximum value for x is preferably 0.5. Especially preferred is 0.3≦x≦0.5, even more preferred is 0.35≦x≦0.5, in particular 0.45<x≦0.5. Further preferred ranges are 0.3≦x≦0.4, 0.4≦x≦0.55.

The stoichiometric value y is preferably at least 0.3. The maximum value of y is preferably 0.6, more preferred 0.55. Especially preferred is 0.3≦y≦0.6, even more preferred is 0.3≦y≦0.55. The lower limit of the stoichiometric value z is preferably at least 0.01, more preferred z is larger than 0.05. The maximum value of z is 0.2, preferably 0.16, more preferred z is at maximum 0.1, particularly preferred the maximum value of z is 0.09. Especially preferred is 0<z≦0.16, more preferred 0.01≦z≦0.16 and even more preferred 0.01≦z≦0.1 and especially preferred 0.01≦z≦0.09. The afore-mentioned values for z are especially preferred when 0.45<x≦0.55. Another especially preferred range of z is 0.03<z≦0.1, even more preferred 0.05<z≦0.1, most preferred 0.05<z≦0.09.

If 0.25≦x<0.45, an especially preferred range of z is 0<z≦0.05.

The stoichiometric value u may differ from 0 by small values, u is preferably −0.06≦u≦0.05, in particular −0.06≦u≦−0.04. One advantage of the present inventive materials is the possibility to easily get a limited hysteresis by balancing simultaneously Mn/Fe and P/Si ratios with a fine adjustment of z. For cyclically operated devices, the thermal hysteresis should not exceed the adiabatic temperature change induced by the available magnetic field. The thermal hysteresis (in zero magnetic field) is preferably ≦6° C., more preferably ≦3° C.

Inventive materials showing especially good properties in respect to the simultaneous presence of large values of ΔS and ΔT_{ad}, small hysteresis and small cell volume change at T_{C} are

i) magnetocaloric materials of formula (I) wherein
0.4≦x≦0.55,
0.3≦y≦0.55, and
0.03≦z≦0.1, preferably 0.05<z≦0.1, most preferred 0.05<z≦0.09;
ii) magnetocaloric materials of formula (I) wherein
0.3≦x≦0.4,
0.3≦y≦0.55, and
0<z≦0.05, preferably 0.01≦z≦0.05;

Magnetocaloric materials i) have a Mn/Fe ratio close to 1 which is especially favourable to reach high magnetization values.

Magnetocaloric materials of general formula ii) are materials which are iron rich. Related boron free magnetocaloric materials are suited magnetocaloric materials too, but may have too large thermal hysteresis. The substitution of a part of the Si and/or P in the composition by boron yields good magnetocaloric materials with lower thermal hysteresis as shown for instance by the comparison of Mn_{0.75}Fe_{1.2}P_{0.66}Si_{0.34} showing a thermal hysteresis of about 18 K with Mn_{0.75}Fe_{1.2}P_{0.63}Si_{0.34}B_{0.03} having a hysteresis below 4 K.

The inventive magnetocaloric materials have preferably the hexagonal crystalline structure of the Fe₂P type.

The inventive magnetocaloric materials exhibit only small or practical no volume change at the magnetic phase transition whereas similar boron free magnetocaloric materials clearly show volume steps at the magnetic phase transition. Preferably, the inventive magnetocaloric materials exhibit a relative volume change |ΔV/V| at the magnetic phase transition of at maximum 0.05%, more preferred of at maximum 0.01%, most preferred the maximum value of |ΔV/V| is equal to the value caused by the mere thermal expansion of the inventive magnetocaloric material at the magnetic phase transition. The value of |ΔV/V| may be determined by X-ray diffraction.

The inventive magnetocaloric materials may be prepared in any suitable manner. The inventive magnetocaloric materials may be produced by solid phase conversion or liquid phase conversion of the starting elements or starting alloys for the magnetocaloric material, subsequently cooling, optionally pressing, sintering and heat treating in one or several steps under inert gas atmosphere and subsequently cooling to room temperature, or by melt spinning of a melt of the starting elements or starting alloys.

Preferably the starting materials are selected from the elements Mn, Fe, P, B and Si, i.e. from Mn, Fe, P, B and Si in elemental form, and from the alloys and compounds formed by said elements among each other. Non-limiting examples of such compounds and alloys formed by the elements Mn, Fe, P, B and Si are Mn₂P, Fe₂P, Fe₂Si and Fe₂B.

Solid phase reaction of the starting elements or starting alloys may be performed in a ball mill. For example, suitable amounts of Mn, Fe, P, B and Si in elemental form or in the form of preliminary alloys such as Mn₂P, Fe₂P or Fe₂B are ground in a ball mill. Afterwards, the powders are pressed and sintered under a protective gas atmosphere at temperatures in the range from 900 to 1300° C., preferably at about 1100° C., for a suitable time, preferably 1 to 5 hours, especially about 2 hours. After sintering the materials are heat treated at temperatures in the range from 700 to 1000° C., preferably about 950° C., for suitable periods, for example 1 to 100 hours, more preferably 10 to 30 hours, especially about 20 hours. After cooling down, a second heat treatment is preferably carried out, in the range from 900 to 1300° C., preferably at about 1100° C., for a suitable time, preferably 1 to 30 hours, especially about 20 hours.

Alternatively, the element powders or preliminary alloy powders can be melted together in an induction oven. It is then possible in turn to perform heat treatments as specified above.

Processing via melt spinning is also possible. This allows obtaining a more homogeneous element distribution which leads to an improved magnetocaloric effect; cf. Rare Metals, Vol. 25, October 2006, pages 544 to 549. In the process described there, the starting elements are first induction-melted in an argon gas atmosphere and then sprayed in the molten state through a nozzle onto a rotating copper roller. This is followed by sintering at 1000° C. and slow cooling to room temperature. In addition, reference may be made to U.S. Pat. No. 8,211,326 and US 2011/0037342 for the production.

Preference is given to a process for producing the inventive magnetocaloric materials comprises the following steps
(a) reacting the starting materials in a stoichiometry which corresponds to the magnetocaloric material in the solid and/or liquid phase obtaining a solid or liquid reaction product,
(b) if the reaction product obtained in step (a) is in the liquid phase, transferring the liquid reaction product from step (a) into the solid phase obtaining a solid reaction product,
(c) optionally shaping of the reaction product from step (a) or (b)
(d) sintering and/or heat treating the solid product from step (a), (b) or (c),
(e) quenching the sintered and/or heat treated product of step (d) at a cooling rate of at least 10 K/s, and
(f) optionally shaping of the product of step (e).

According to one preferred embodiment of the present invention step (c) shaping of the reaction product from step (a) or (b) is performed.

In step (a) of the process, the elements and/or alloys which are present in the magnetocaloric material are converted in the solid or liquid phase in a stoichiometry which corresponds to the material. Preference is given to performing the reaction in step a) by combined heating of the elements and/or alloys in a closed vessel or in an extruder, or by solid phase reaction in a ball mill. Particular preference is given to performing a solid phase reaction, which is effected especially in a ball mill. Such a reaction is known in principle; c.f. the documents previously cited. Typically, powders of the individual elements or powders of alloys of two or more of the individual elements which are present in the magnetocaloric material are mixed in pulverized or granular form in suitable proportions by weight. If necessary, the mixture can additionally be ground in order to obtain a microcrystalline powder mixture. This powder mixture is preferably mechanically impacted in a ball mill, which leads to further cold welding and also good mixing, and to a solid phase reaction in the powder mixture.

Alternatively, the elements are mixed as a powder in the selected stoichiometry and then melted. The combined heating in a closed vessel allows the fixing of volatile elements and control of the stoichiometry. Specifically in the case of use of phosphorus, this would evaporate easily in an open system.

Step (a) is preferably performed under inert gas atmosphere.

If the reaction product obtained in step (a) is in the liquid phase, the liquid reaction product from step (a) is transferred into the solid phase obtaining a solid reaction product in step (b).

The reaction is followed by sintering and/or heat treatment of the solid in step (d), for which one or more intermediate steps can be provided. For example, the solid obtained in step (a) can be subjected to shaping in step (c) before it is sintered and/or heat treated.

For example, is possible to send the solid obtained from the ball mill to a melt spinning process. Melt-spinning processes are known per se and are described, for example, in Rare Metals, Vol. 25, October 2006, pages 544 to 549, and also in U.S. Pat. No. 8,211,326 and WO 2009/133049. In these processes, the composition obtained in step (a) is melted and sprayed onto a rotating cold metal roller. This spraying can be achieved by means of elevated pressure upstream of the spray nozzle or reduced pressure downstream of the spray nozzle. Typically, a rotating copper drum or roller is used, which can additionally optionally be cooled. The copper drum preferably rotates at a surface speed of 10 to 40 m/s, especially from 20 to 30 m/s. On the copper drum, the liquid composition is cooled at a rate of preferably from 10² to 10⁷ K/s, more preferably at a rate of at least 10⁴ K/s, especially with a rate of from 0.5 to 2*10⁶ K/s.

The melt spinning, like the reaction in step (a), can be performed under reduced pressure or under an inert gas atmosphere.

The melt spinning achieves a high processing rate, since the subsequent sintering and heat treatment can be shortened. Specifically on the industrial scale, the production of the magnetocaloric materials thus becomes significantly more economically viable. Melt spinning also leads to a high processing rate. Particular preference is given to performing melt spinning.

Melt spinning can be performed to transfer the liquid reaction product obtained from step (a) into a solid according to step (b), too. According to one embodiment of the present invention one of step (a) and (b) comprise melt spinning.

Alternatively, in step (b), spray cooling can be carried out, in which a melt of the composition from step (a) is sprayed into a spray tower. The spray tower may, for example, additionally be cooled. In spray towers, cooling rates in the range from 10³ to 10⁵ K/s, especially about 10⁴ K/s, are frequently achieved.

In step (c) optionally shaping of the reaction product of step (a) or (b) is performed. Shaping of the reaction products may be performed by the shaping methods known to the person skilled in the art like pressing, molding, extrusion etc.

Pressing can be carried out, for example, as cold pressing or as hot pressing. The pressing may be followed by the sintering process described below.

In the sintering process or sintered metal process, the powders of the magnetocaloric material are first converted to the desired shape of the shaped body, and then bonded to one another by sintering, which affords the desired shaped body. The sintering can likewise be carried out as described below.

It is also possible in accordance with the invention to introduce the powder of the magnetocaloric material into a polymeric binder, to subject the resulting thermoplastic molding material to a shaping, to remove the binder and to sinter the resulting green body. It is also possible to coat the powder of the magnetocaloric material with a polymeric binder and to subject it to shaping by pressing, if appropriate with heat treatment.

According to the invention, it is possible to use any suitable organic binders which can be used as binders for magnetocaloric materials. These are especially oligomeric or polymeric systems, but it is also possible to use low molecular weight organic compounds, for example sugars.

The magnetocaloric powder is mixed with one of the suitable organic binders and filled into a mold. This can be done, for example, by casting or injection molding or by extrusion. The polymer is then removed catalytically or thermally and sintered to such an extent that a porous body with monolith structure is formed.

Hot extrusion or metal injection molding (MIM) of the magnetocaloric material is also possible, as is construction from thin sheets which are obtainable by rolling processes. In the case of injection molding, the channels in the monolith have a conical shape, in order to be able to remove the moldings from the mold. In the case of construction from sheets, all channel walls can run in parallel.

Steps (a) to (c) are followed by sintering and/or heat treatments of the solid, for which one or more intermediate steps can be provided.

The sintering and/or heat treatments of the solid is effected in step (d) as described above. In the case of use of the melt-spinning process, the period for sintering or heat treatments can be shortened significantly, for example toward periods of from 5 minutes to 5 hours, preferably from 10 minutes to 1 hour. Compared to the otherwise customary values of 10 hours for sintering and 50 hours for heat treatment, this results in a major time advantages. The sintering/heat treatment results in partial melting of the particle boundaries, such that the material is compacted further.

The melting and rapid cooling comprised in steps (a) to (c) thus allows the duration of step (d) to be reduced considerably. This also allows continuous production of the magnetocaloric materials.

The sintering and/or heat treatment of the compositions obtained from one of steps (a) to (c) is effected in step (d). The maximal temperature of the sintering (T<melting point) is a strong function of composition. Extra Mn decreases the melting point and extra Si increases it. Preferably the compositions are first sintered at a temperature in the range from 800 to 1400° C., more preferred in the range from 900 to 1300° C. For shaped bodies/solids, the sintering is more preferably effected at a temperature in the range from 1000 to 1300° C., especially from 1000 to 1200° C. The sintering is performed preferably for a period of from 1 to 50 hours, more preferably from 2 to 20 hours, especially from 5 to 15 hours (step d1). After sintering the compositions are preferably heat treated at a temperature in the range of from 500 to 1000° C., preferably in the range of from 700 to 1000° C., but even more preferred are the aforementioned temperature ranges outside the range of 800 to 900° C., i.e the heat treatment is preferably performed at a temperature T wherein 700° C.<T<800° C. and 900° C.<T<1000° C. The heat treatment is performed preferably for a period in the range from 1 to 100 hours, more preferably from 1 to 30 hours, especially from 10 to 20 hours (step d2). This heat treatment may then followed by a cool down to room temperature, which is preferably carried out slowly (step d3). An additional second heat treatment may be carried out at temperatures in the range of from 900 to 1300° C., preferably in the range of from 1000 to 1200° C. for a suitable period like, preferably 1 to 30 hours, preferably 10 to 20 hours (step d4).

The exact periods can be adjusted to the practical requirements according to the materials. In the case of use of the melt-spinning process, the period for sintering or heat treatment can be shortened significantly, for example to periods of from 5 minutes to 5 hours, preferably from 10 minutes to 1 hour. Compared to the otherwise customary values of 10 hours for sintering and 50 hours for heat treatment, this results in a major time advantage.

The sintering/heat treatment results in partial melting of the particle boundaries, such that the material is compacted further.

The melting and rapid cooling in step (b) or (c) thus allows the duration of step (d) to be reduced considerably. This also allows continuous production of the magnetocaloric materials.

Preferably step (d) comprises the steps

(d1) sintering,
(d2) first heat treatment,
(d3) cooling, and
(d4) second heat treatment.

Steps (d1) to (d4) may be performed as described above.

In step (e) quenching the sintered and/or heat treated product of step (d) at a cooling rate of at least 10 K/s, preferably of at least 100 K/s is performed. The thermal hysteresis and the transition width can be reduced significantly when the magnetocaloric materials are not cooled slowly to ambient temperature after the sintering and/or heat treatments, but rather are quenched at a high cooling rate. This cooling rate is at least 10 K/s, preferably at least 100 K/s.

The quenching can be achieved by any suitable cooling processes, for example by quenching the solid with water or aqueous liquids, for example cooled water or ice/water mixtures. The solids can, for example, be allowed to fall into ice-cooled water. It is also possible to quench the solids with subcooled gases such as liquid nitrogen. Further processes for quenching are known to those skilled in the art. The controlled and rapid character of the cooling is advantageous especially in the temperature range between 800 and 900° C., i.e. it is preferred to keep the exposure of the material to temperatures in the range between 800 and 900° C. as short as possible.

The rest of the production of the magnetocaloric materials is less critical, provided that the last step comprises the quenching of the sintered and/or heat treated solid at the large cooling rate.

In step (f) the product of step (e) may be shaped. The product of step (e) may be shaped by any suitable method known by the person skilled in the art, e.g. by bonding with epoxy resin or any other binder. Performing shaping step (f) is especially preferred if the product of step (e) is obtained in form of a powder or small particles.

The inventive magnetocaloric materials can be used in any suitable applications. For example, they can be used in cooling systems like refrigerators and climate control units, heat exchangers, heat pumps or thermoelectric generators. Particular preference is given to use in cooling systems. Further object of the present invention are cooling systems, heat exchangers, heat pumps and thermoelectric generators comprising at least one inventive magnetocaloric material as described above. The invention is hereafter illustrated in detail by examples and by referring to state of the art in the magnetic refrigeration field.

### EXAMPLES

### A) Preparation of the Magnetocaloric Materials

All the examples described hereafter are synthesized according to the same protocol. Stoichiometric quantities of Mn flakes, B flakes, and powders of Fe₂P, P, and Si were ground in a planetary ball mill for 10 h with a ball to sample weight ratio of 4. The resulting powders were then pressed into pellets and sealed in quartz ampules under Ar atmosphere of 200 mbar. The heat treatment was performed via a multiple steps process: first, a sintering at 1100° C. for 2 hours, followed by a first 20 hours heat treatment at 850° C. was performed. Subsequently the samples were cooled down to room temperature in the furnace. Finally, the samples were heat treated at 1100° C. for 20 hours followed by rapid quenching of the samples by dropping the hot quartz ampules into water at room temperature.

The compositions of the materials prepared are summarized in Table 1.

TABLE 1
Compositions

| Example | Formula | z |
|---|---|---|
| 1 (comparative) | MnFe_{0.95}P_{2/3-z}B_{z}Si_{1/3} | 0.00 |
| 2 (inventive) | MnFe_{0.95}P_{2/3-z}B_{z}Si_{1/3} | 0.02 |
| 3 (inventive) | MnFe_{0.95}P_{2/3-z}B_{z}Si_{1/3} | 0.04 |
| 4 (inventive) | MnFe_{0.95}P_{2/3-z}B_{z}Si_{1/3} | 0.06 |
| 5 (inventive) | MnFe_{0.95}P_{2/3-z}B_{z}Si_{1/3} | 0.065 |
| 6 (inventive) | MnFe_{0.95}P_{2/3-z}B_{z}Si_{1/3} | 0.07 |
| 7 (inventive) | MnFe_{0.95}P_{2/3-z}B_{z}Si_{1/3} | 0.075 |
| 8 (inventive) | MnFe_{0.95}P_{2/3-z}B_{z}Si_{1/3} | 0.08 |
| 9 (inventive) | MnFe_{0.95}P_{2/3-z}B_{z}Si_{1/3} | 0.085 |
| 10 (inventive) | MnFe_{0.95}P_{2/3-z}B_{z}Si_{1/3} | 0.09 |
| 11 (inventive) | MnFe_{0.95}P_{2/3-z}B_{z}Si_{1/3} | 0.10 |
| 12 (comparative) | MnFe_{0.95}P_{0.55}Si_{0.45} | |
| 13 (inventive) | MnFe_{0.95}P_{0.48}B_{0.07}Si_{0.45} | 0.07 |
| 14 (comparative) | Mn_{1.1}Fe_{0.85}P_{2/3}Si_{1/3} | |
| 15 (inventive) | Mn_{1.1}Fe_{0.85}P_{0.60}B_{0.07}Si_{0.33} | 0.07 |
| 16 (comparative) | Mn_{0.85}Fe_{1.1}P_{2/3}Si_{1/3} | |
| 17 (inventive) | Mn_{0.85}Fe_{1.1}P_{0.60}B_{0.07}Si_{0.33} | 0.07 |
| 18 (comparative) | Mn_{1.25}Fe_{0.7}P_{0.5}Si_{0.5} | |
| 19 (comparative) | Mn_{0.75}Fe_{1.2}P_{0.66}Si_{0.34} | |
| 20 (inventive) | Mn_{0.75}Fe_{1.2}P_{0.63}B_{0.03}Si_{0.34} | 0.03 |

If B is not present the composition can be given very accurate. However, especially if very small quantities of B it is difficult to determine the value of z very precisely. This has to do with the affinity of B to oxygen. If oxygen is present in the sample, which is almost inevitable, part of the B will react to B₂O₃ which is volatile and thus will not enter the compound. Usually the error of z is about ±0.01.

In order to highlight the role played by the boron substitution according to the present invention, especially regarding hysteresis and transition temperature adjustments, a set of values x, y and u were chosen on the basis of the general formula (MnₓFe₁₋ₓ)₂₊ᵤP_{1-y-z}Si_{y}B_{z} and kept constant during the examples 1 to 11 with x=0.51, y=1/3, u=−0.05.

To serve as comparisons with the materials described in US 2011/0167837 and US 2011/0220838, additional examples (with and without boron) were also prepared: “silicon rich” materials with x=0.51, y=0.45 and u=−0.05 (examples 12 and 13), “manganese rich” materials with x about 0.55, y=1/3 and u=−0.05 (examples 14, 15) and “iron rich” materials with x=0.43 and x=0.39, y=1/3 and u=−0.05 (examples 16, 17, 19 and 20).

### B) Measurements

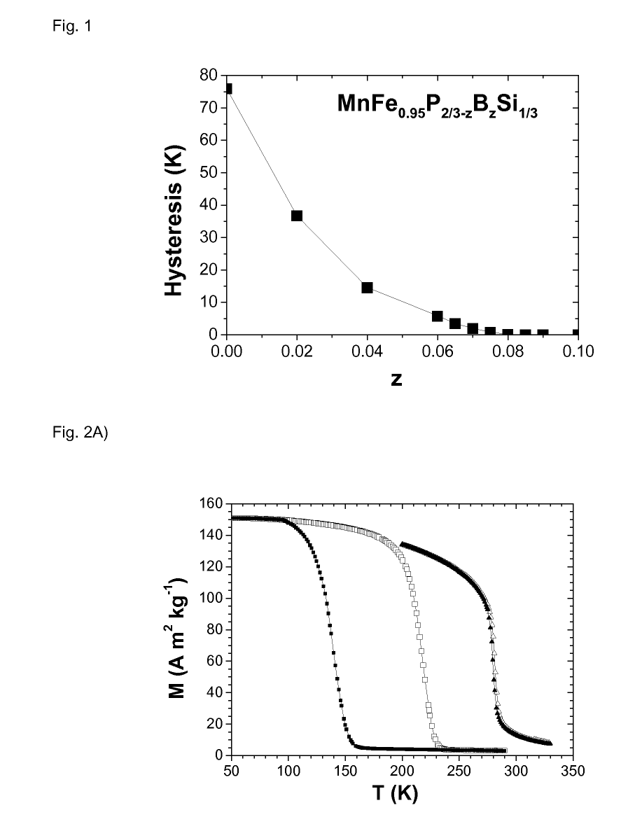

The specific heat of the examples was measured in a differential scanning calorimeter in zero field at a sweep rate of 10 Kmin⁻¹. The thermal hysteresis in FIG. 1 is defined as the difference between the locations of the heat capacity peaks upon warming and upon cooling. For all the magnetocaloric materials listed in table 1, the magnetic transition is accompanied by a symmetrical specific heat peak indicating that we are dealing with first order transitions, that is to say with Giant-magnetocaloric materials as described in K. A. Geschneidner Jr., V. K. Pecharsky and A. O. Tsokol, Rep. Prog. Phys. 68, 1479 (2005).

The magnetic properties of the examples were determined in a Quantum Design MPMS 5XL SQUID magnetometer.

The entropy change was derived on the basis of isofield magnetization measurements and the use of the so-called Maxwell relation (see A. M. G. Carvalho et al., J. Alloys Compd. 509, 3452 (2011)).

ΔT_{ad} was measured by a direct method on a home-made device. Magnetic field changes of 1.1 T were applied by moving/removing (1.1 Ts⁻¹) the samples from the magnetic field generated by a permanent magnet. A relaxation time of 4 s was used between each field changes, and thus, the duration of a full magnetization/demagnetization cycle was 10 s. The starting temperature of each cycle was externally controlled and swept between 250 K and 320 K at a rate of 0.5 Kmin⁻¹. It should be noted that the time required for the ΔT_{ad} to take place is generally of the order of 1 s or less, almost instantaneous compared to the sweeping rate.

The structural parameters were studied by collecting x-ray diffraction patterns at various temperatures in zero magnetic field in a PANalytical X-pert Pro diffractometer equipped with an Anton Paar TTK450 low temperature chamber. Structure determination and refinements were performed with the FullProf software (see http://www.ill.eu/sites/fullprof/index.html) and show that all the samples listed in table 1 crystallize in the hexagonal Fe₂P-type structure (space group P_{6̅2m}).

### C) Results

In FIG. 1 the thermal hysteresis of examples 1 to 11 are depicted. These data display the evolution of the thermal hysteresis as function of the boron content z wherein x, y and u were kept constant at x=0.51, y=1/3, u=−0.05. There is a rapid decrease of the hysteresis as function of z. As can be seen, it is possible to obtain small values of thermal hysteresis for broad ranges of x, y and u values by a fine control of z. For the present selected examples, the z range leading to a thermal hysteresis in line with the preferred low value of the hysteresis of at maximum 6° C. is 0.06≦z≦0.1.

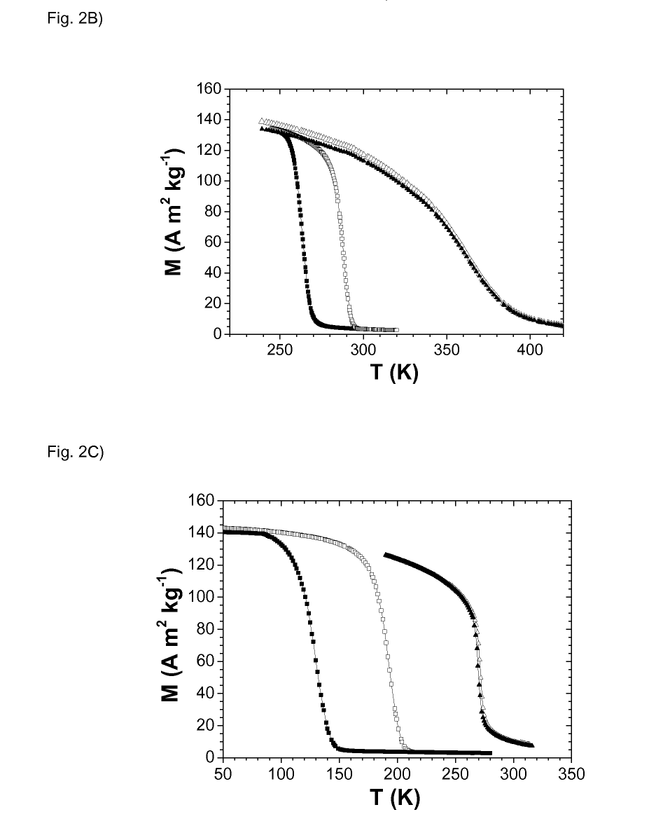

FIGS. 2A) to E) show the magnetization data measured in a field of B=1 T upon warming (open symbols) and upon cooling (closed symbols) at a sweep rate of 1 Kmin⁻¹. These data illustrate the capability of boron substitution to reduce the hysteresis in comparison to the parameters proposed in US 2011/0167837 and US 2011/0220838. The following observations can be made:

FIG. 2A): The thermal hysteresis of MnFe_{0.95}P_{2/3}Si_{1/3} (example 1; squares) is about 77 K, while it is only 1.9 K for MnFe_{0.95}P_{0.595}B_{0.075}Si_{0.33} (example 7; triangles), the average hysteresis decreased is thus about −10 K per percent of boron.

FIG. 2B) Starting from MnFe_{0.95}P_{0.67}Si_{0.33} (example 1 shown in FIG. 2A), the increased silicon content of MnFe_{0.95}P_{0.55}Si_{0.45} (example 12; squares) leads to a visible but low decrease of the hysteresis of about −1.8 K per percent of silicon. The substitution by boron in this sample leads to a very small hysteresis as shown by MnFe_{0.95}P_{0.48}B_{0.07}Si_{0.45} (example 13; triangles) having a hysteresis of only 0.5 K.

FIG. 2C): Starting from MnFe_{0.95}P_{2/3}Si_{1/3} (example 1 shown in FIG. 2A), the increase of the manganese content of Mn_{1.1}Fe_{0.85}P_{2/3}Si_{1/3} (example 14; squares) leads to a decrease of the hysteresis of about −4 K per percent of manganese. The substitution by boron in this sample leads to a very small hysteresis as shown by Mn_{1.1}Fe_{0.85}P_{0.60}B_{0.07}Si_{0.33} (example 15, triangles) having a hysteresis of 1 K.

FIG. 2D): Starting from MnFe_{0.95}P_{2/3}Si_{1/3} (example 1 shown in FIG. 2A), the increase of the iron content of Mn_{0.85}Fe_{1.1}P_{2/3}Si_{1/3} (example 16; squares) leads to a decrease of the hysteresis of about −2.5 K per percent of iron. The substitution by boron in this sample leads to a very small hysteresis as shown by Mn_{0.85}Fe_{1.1}P_{0.60}B_{0.07}Si_{0.33} (example 17; triangles) having a hysteresis of 1.5 K.

FIG. 2E): Starting from MnFe_{0.95}P_{2/3}Si_{1/3} (example 1 shown in FIG. 2A), a significant increase of the iron content of Mn_{0.75}Fe_{1.2}P_{0.66}Si_{0.34} (example 19; squares) leads to a material still presenting a sizable hysteresis of 18 K. The substitution of a part of the Si and/or P in the composition by boron to this sample leads to a limited hysteresis as shown by Mn_{0.75}Fe_{1.2}P_{0.63}B_{0.03}Si₀₃₄ (example 20, triangles) having a hysteresis lower than 4 K.

It thus appears that boron substitution is more efficient than any other parameters proposed in US 2011/0167837 and US 2011/0220838 to control the hysteresis. Moreover, the substitution by boron can be used to reduce the hysteresis for all kinds of compositions, in “Si rich” (example 13), “Mn rich” (examples 15) and “Fe rich” (example 17 and 20) materials.

It should also be noted that in all the examples displayed in the FIGS. 2A) to 2E), the substitution of phosphorous by boron does not affect the magnetization in the ferromagnetic state.

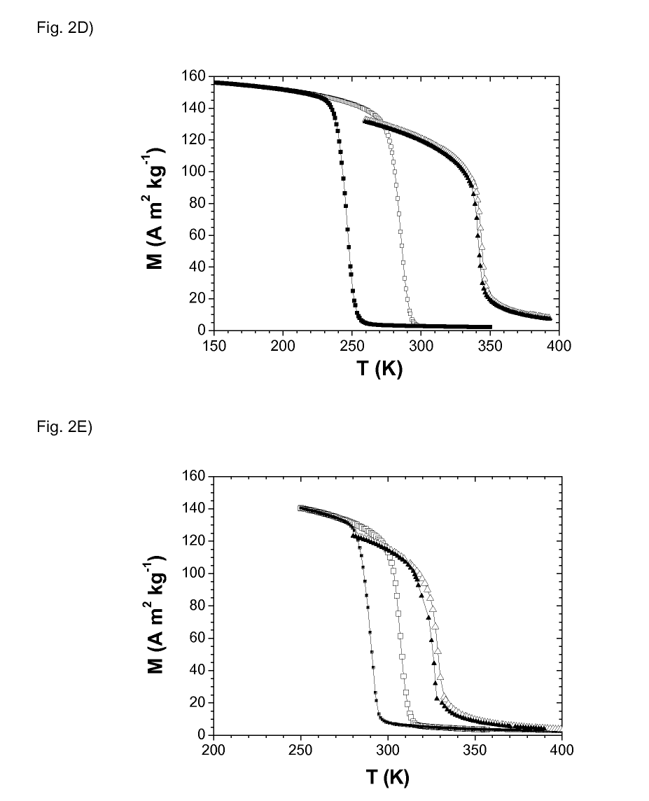

FIG. 3A) shows a set of MB(T) curves for MnFe_{0.95}P_{0.595}B_{0.075}Si_{0.33} (example 7) between 0.25 T and 2 T (increments of 0.25 T), measured upon warming with a sweeping rate of 1 Kmin⁻¹. A large magnetization jump of about 72 Am² kg⁻¹ is found at the magnetic phase transition at B=1 T leading to a large magnetocaloric effect in this temperature range. The sensitivity of the magnetic phase transition in respect to the magnetic field dTc/dB of example 7 is shown in FIG. 3B) (the squares correspond to the experimental Tcs, the line is a linear fit). dTc/dB of example 7 amounts to +4.4±0.2 KT⁻¹ which is higher than for (MnₓFe₁₋ₓ)₂₊ᵤP_{1-y}Si_{y} compounds, see Phys. Rev. B 86, 045134 (2012). This is in agreement with the objective of the invention and will induce large adiabatic temperature changes in these boron substituted compounds.

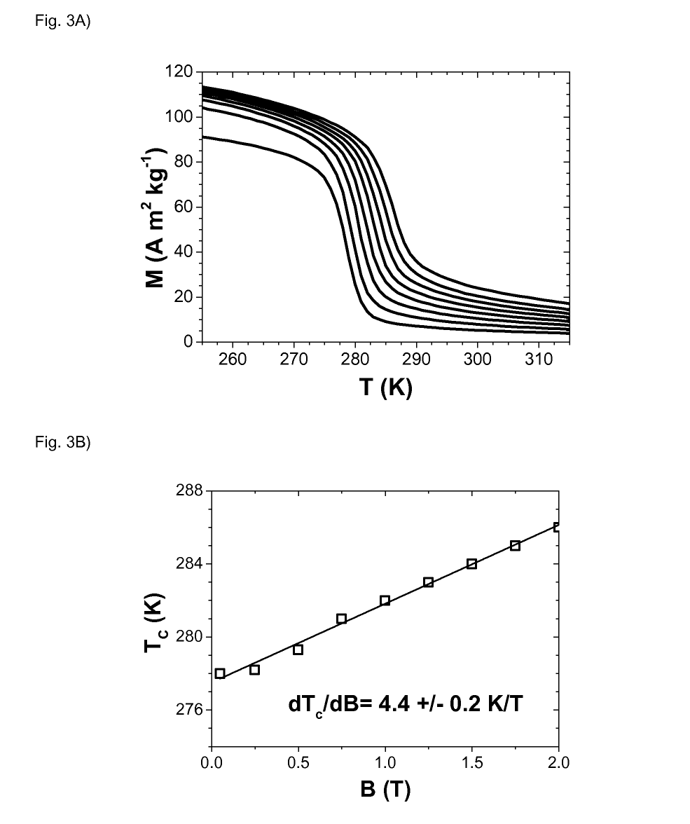

FIG. 4 presents ΔS values of examples 5 to 7 with x=0.51, y=1/3, u=−0.05 and z=0.065 (example 5; triangles), z=0.07 (example 6; circles), and z=0.075 (example 7; squares) for field changes of 1 T (open symbols) and 2 T (closed symbols). The maximal values of |ΔS| for ΔB=1 T are about 10-12 J kg⁻¹K⁻¹, and thus, are well in line with those obtained in the materials having a “giant” magnetocaloric effect (see review K. A. Geschneidner Jr., V. K. Pecharsky and A. O. Tsokol, Rep. Prog. Phys. 68, 1479 (2005)).

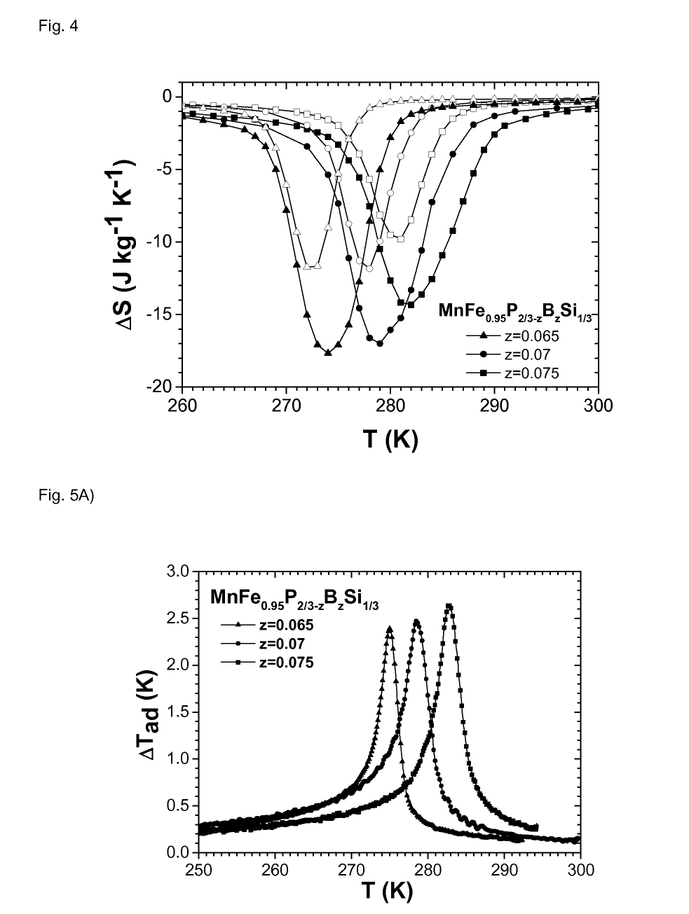

FIG. 5A) shows the adiabatic temperature changes ΔT_{ad} of the examples 5, 6 and 7. Maximal values of about 2.5 to 2.7 K are obtained with the samples containing boron, which is very close to the highest values reported so-far in giant magnetocaloric materials around room temperature (see review K. A. Geschneidner Jr., V. K. Pecharsky and A. O. Tsokol, Rep. Prog. Phys. 68, 1479 (2005)). It is worth noting that these measured ΔT_{ad} correspond to a fully reversible effect since they are determined during continuous cycling operations, see FIG. 5B) for z=0.075 (example 7, the squares correspond to the sample temperatures, the arrows mark the magnetic field changes). This is in strong contrast to similar ΔT_{ad} values published recently, where the ΔT_{ad} measured during cycling operation is only one third of the non-reversible ΔT_{ad} value (see “Giant magnetocaloric effect driven by structural transitions”, by J. Liu, T. Gottschall, et al. in Nature Mat. 11, 620 (2012)). For similar reasons (too large hysteresis), the compositions displayed in CN 102881393A, which show a thermal hysteresis from 12 K to 27 K, will not have any significant reversible ΔT_{ad} in intermediate magnetic field (for ΔB≦2 T); that is to say these compositions cannot be used in a cyclic application like a magnetic refrigerator (c.f. description of the ΔT_{ad} of example 12 which corresponds to a similar “large hysteresis” case).

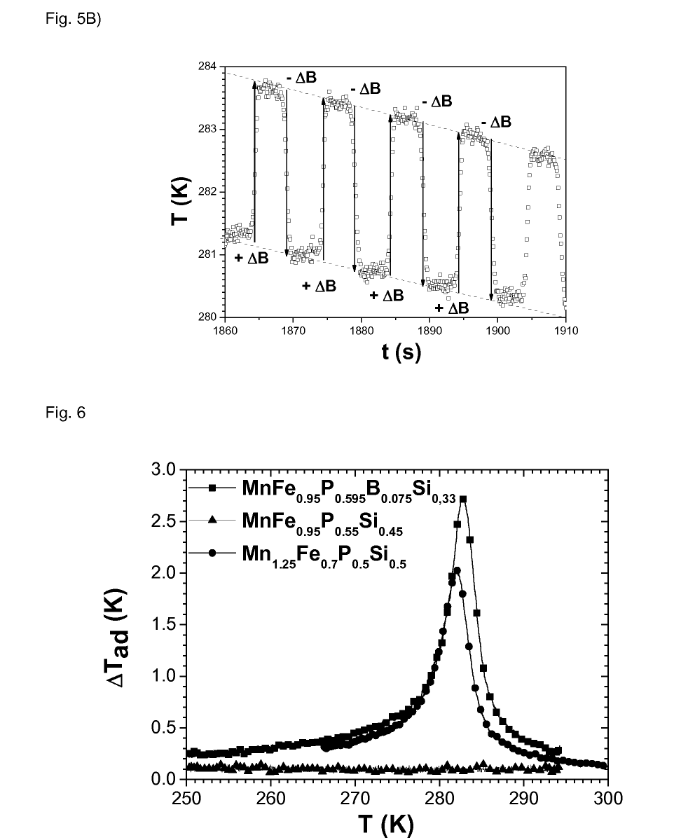

FIG. 6 displays ΔT_{ad} of a boron substituted compound (MnFe_{0.95}P_{0.595}B_{0.075}Si_{0.33}; example 7; squares) and of compounds without boron (MnFe_{0.95}P_{0.55}Si_{0.45}; example 12; triangles) and (Mn_{1.25}Fe_{0.7}P_{0.5}Si_{0.5}; example 18; circles). The boron free composition (example 12) based on the same Mn/Fe ratio as the composition containing boron (example 7) does not show any “reversible” ΔT_{ad}, which is a direct consequence of the pronounced hysteresis observed with this composition. The parameters z=0, x=0.51 and u=−0.05 of example 12 are the same as in the boron containing sample (example 7); while y has been slightly increased toward y=0.45 in order to get a T_{C} close to room temperature: at 289 K upon warming and 265 K upon cooling, cf. FIG. 2B). Compared to example 18, which is one of the particular compositions of US 2011/0167837 (MnₓFe₁₋ₓ)₂₊ᵤP_{1-y}Si_{y} (x=0.65, y=1/2, u=−0.05) and has a ΔT_{ad}=2.05 K, the example 7 containing boron has a much higher ΔT_{ad}, the improvement of the ΔT_{ad} in boron substituted compositions is of about +30%.

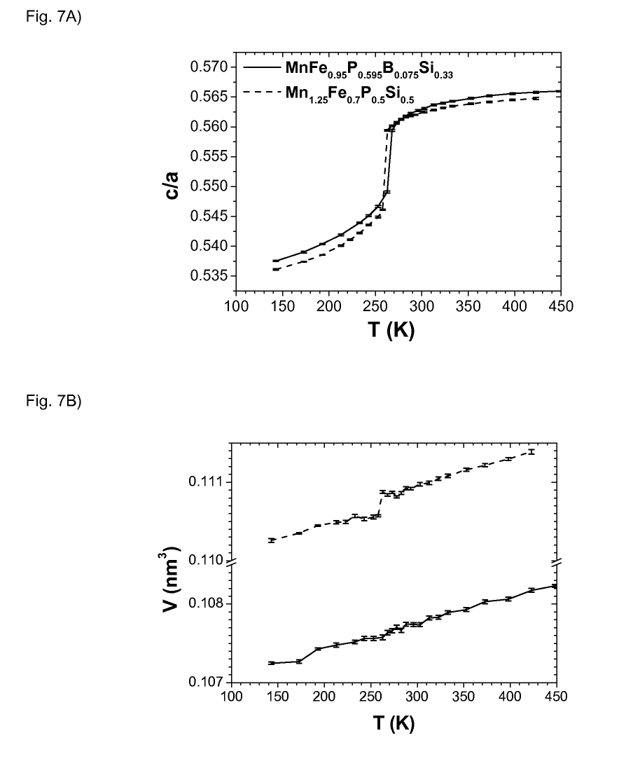

FIG. 7A) displays the ratio between the c and a cell parameters determined by x-ray diffraction. The unit cell of the preferred materials of formula (MnₓFe₁₋ₓ)₂₊ᵤP_{1-y-z}Si_{y}B_{z} is hexagonal, the “structural” changes at the magnetic phase transition are not isotropic. For MnFe_{0.95}P_{0.595}B_{0.075}Si_{0.33} (example 7, full line) a jump of the cell parameters at T_{C} was observed which was as pronounced as in a composition without boron (Mn_{1.25}Fe_{0.7}P_{0.5}Si_{0.5}; example 18, dashed line). But as shown in FIG. 7B) for the boron substituted sample (full line) no jump of the cell volume was observed, while there was a sizable ΔV/V of about +0.25% in Mn_{1.25}Fe_{0.7}P_{0.5}Si_{0.5} (dashed line). The ΔV of about 0 observed for boron substituted samples turns out to be smaller than ΔV of (Mn,Fe)₂(P, As) based materials where ΔV/V=−0.44% (see Jap. J. of Appl. Phy. 44, 549 (2005)), (Mn,Fe)₂(P, Ge) based materials where ΔV/V=+0.1% (see J. Phys. Soc. Jpn. 75, 113707 (2006)) and (Mn,Fe)₂(P, Si) based materials where ΔV/V=+0.25% (as aforesaid). To our knowledge, this is the first time that a ΔV of about 0 which is practically the mere thermal expansion, i.e. without any discontinuity like a jump or step in the temperature dependence, is observed at the first order transition of a giant MCE material.

This very small ΔV at T_{C} in boron substituted samples gives a good mechanical stability to these samples. The good mechanical stability has been confirmed by cycling a MnFe_{0.95}P_{0.595}B_{0.075}Si_{0.33} sample (example 7) across the transition during direct ΔT_{ad} measurements. The shape of the sample for ΔT_{ad} measurements corresponds to a thin cylinder of 10 mm diameter and 1 mm thickness. Even after the 8000 cycles of magnetization/demagnetization used for the ΔT_{ad} measurement, this sample geometry remains intact and the mechanical integrity is maintained. It should be noted that the same experimental methods have already been used to check the mechanical stability of giant MCE materials, for instance in La(Fe,Si)₁₃ based materials (Adv. Mat. 22, 3735 (2010)).

1. A magnetocaloric material of the formula (I)
(MnₓFe₁₋ₓ)₂₊ᵤP_{1-y-z}Si_{y}B_{z}
wherein
0.25<x≦0.55,
0.25≦y≦0.65,
0<z≦0.2
−0.1≦u≦0.05, and
y+z≦0.7.

2. The magnetocaloric material according to claim 1, wherein 0.3≦x≦0.5.

3. The magnetocaloric material according to claim 1, wherein 0.3≦y≦0.6.

4. The magnetocaloric material according to claim 1, wherein 0.01≦z≦0.16.

5. The magnetocaloric material according to claim 1, wherein 0.05<z≦0.10.

6. The magnetocaloric material according to claim 1, wherein −0.1≦u≦0.

7. The magnetocaloric material according to claim 1, wherein −0.06≦u≦−0.04.

8. The magnetocaloric material according to claim 1, wherein 0.4≦x≦0.55, 0.3≦y≦0.55, and 0.05<z≦0.1.

9. The magnetocaloric material according to claim 1, which has a hexagonal crystalline structure of the Fe₂P type.

10. The magnetocaloric material according to claim 1, which shows a value of |ΔV/V|<0.05% at the magnetic phase transition determined by X-ray diffraction.

11. A process for producing the magnetocaloric materials according to claim 1, comprising:
(a) reacting the starting materials in a stoichiometry which corresponds to the magnetocaloric material in the solid and/or liquid phase obtaining a solid or liquid reaction product,
(b) if the reaction product obtained in (a) is in the liquid phase, transferring the liquid reaction product from (a) into the solid phase obtaining a solid reaction product,
(c) optionally shaping of the reaction product from (a) or (b)
(d) sintering and/or heat treating the solid product from (a), (b) or (c),
(e) quenching the sintered and/or heat treated product of (d) at a cooling rate of at least 10 K/s, and
(f) optionally shaping of the product of (e).

12. The process according to claim 11, wherein the shaping (c) is performed.

13. The process according to claim 11, wherein the starting materials are selected from the elements Mn, Fe, P, B and Si and the alloys and compounds formed by the elements.

14. The magnetocaloric materials according to claim 1, wherein the materials are suitable in cooling systems, heat exchangers, heat pumps or thermoelectric generators.

15. Cooling systems, heat exchangers, heat pumps and thermoelectric generators comprising at least one magnetocaloric material according to claim 1.
